(19) United States
(12) Patent Application Publication
(10) Pub. No.: US 2026/0307617 A1
(43) Pub. Date: Oct. 8, 2026

(54) AUTOMOTIVE COMPOSABLE SECURITY DEFENSE LEVELS

(71) Applicant: Red Hat, Inc., Raleigh, NC (US)

(72) Inventors: Paolo Antinori, Milan (IT); Andrea Cosentino, Milan (IT)

(21) Appl. No.: 19/170,962

(22) Filed: Apr. 4, 2025

(51) Int. Cl. B60R 25/01; B60R 16/023

(52) U.S. Cl. CPC B60R 25/01; B60R 16/0231

(57) ABSTRACT

Aspects of the present disclosure relate to automotive composable security defense levels. More specifically, a processing device obtains, via a service, a request to transition a vehicle from a first safety level to a second safety level, where the first safety level and the second safety level are associated with an embedded system of the vehicle. The processing device validates, via the service, the request based on a set of security conditions. The processing device transitions, via the service, the vehicle from the first safety level to the second safety level based on the validated request. The processing device adjusts an operational parameter of the embedded system based on the transition from the first safety level to the second safety level.

### TECHNICAL FIELD

Aspects of the present disclosure relate to automotive security, and more particularly, to automotive composable security defense levels.

### BACKGROUND

A vehicle (e.g., an automobile) may include different computing systems that perform different functions within the vehicle. For example, an automobile may include embedded systems (e.g., electronic control units (ECUs)) that control electrical systems or subsystems of the automobile. Example ECUs may include an engine control module (ECM), a powertrain control module (PCM), a transmission control module (TCM), a brake control module (BCM), a central control module (CCM), a central timing module (CTM), a general electronic module (GEM), a body control module, and/or a suspension control module (SCM).

A vehicle (e.g., an automobile) may be a connected vehicle. A connected vehicle refers to a vehicle that is capable of communicating with entities outside of the vehicle and/or inside of the vehicle via a wired connection and/or a wireless connection. In an example, the entities may be or include a user device (e.g., a smartphone) of a user inside or outside of the vehicle, other vehicles, cloud platform, and/or a roadside unit (RSU). A connected vehicle may provide services to passengers (e.g., music services) based on communicating with the entities. A connected vehicle may also support or enhance self-driving functionality as well. A connected vehicle may be capable of vehicle-to-everything (V2X) communications. V2X communications may include vehicle-to-infrastructure (V2I) communications, vehicle-to-vehicle (V2V) communications, vehicle-to-cloud (V2C) communications, vehicle-to-pedestrian (V2P) communications, vehicle-to-device (V2D) communications, vehicle-to-network (V2N) communications, and/or vehicle-to-grid (V2G) communications.

### BRIEF DESCRIPTION OF THE DRAWINGS

The described aspects and the advantages thereof may best be understood by reference to the following description taken in conjunction with the accompanying drawings. These drawings in no way limit any changes in form and detail that may be made to the described aspects by one skilled in the art without departing from the spirit and scope of the described aspects.

FIG. 1 is a block diagram that illustrates an example of a vehicle in accordance with some aspects of the present disclosure.

FIG. 2 is a block diagram that illustrates an example of a state machine in accordance with some aspects of the present disclosure.

FIG. 3 is a block diagram that illustrates an example system in accordance with some aspects of the present disclosure.

FIG. 4 is a flow diagram of a method for automotive composable security defense levels in accordance with some aspects of the present disclosure.

FIG. 5 is a block diagram of an example of a computer system that may perform one or more of the operations described herein in accordance with some aspects of the present disclosure.

### DETAILED DESCRIPTION

As indicated above, a vehicle (e.g., a land-based vehicle, such as an automobile) may include embedded systems (e.g., ECUs) that control systems (i.e., vehicle systems) or subsystems (i.e., vehicle subsystems) of the vehicle. In an example, an automobile may include one-hundred and fifty ECUs that work to control different systems and/or subsystems of the automobile. Furthermore, a vehicle that includes ECUs may be a connected vehicle that is capable of communicating with entities outside of the vehicle and/or inside of the vehicle via a wired connection and/or a wireless connection. As such, a vehicle may be viewed as a collection of computing devices that work to provide different functionality for the vehicle. For instance, the functionality may include navigating the vehicle, providing entertainment services to occupants of the vehicle, controlling a climate inside the vehicle, etc.

As a connected vehicle may be exposed to different entities via the Internet (or another network), ECUs of the vehicle may be at risk for potential cyberattacks much like other non-vehicle based computing devices. In an example, a cyberattack may originate via communication(s) received by the vehicle from entities outside of the vehicle (e.g., a denial-of-service (DoS) attack) or from a compromised device connected to the vehicle (e.g., a smartphone of a driver of the vehicle carrying malware). Some approaches for mitigating cyberattacks to a vehicle may not be well-tailored to the severity of a cyberattack. If a mitigation strategy for a cyberattack is too heavy-handed, operation of the vehicle may be disrupted and/or excessive computing resources of the vehicle may be utilized to address the cyberattack; however, if the mitigation strategy for the cyberattack is not strong enough, the vehicle may be at risk. Moreover, some approaches for mitigating cyberattacks may not take into account certain safety standards (e.g., functional safety (FuSa)) and/or may not take into account operational realities of the vehicle. For instance, if a mitigation strategy for a cyberattack is to turn off an engine of the vehicle and receive a software update, and the vehicle is currently travelling on a highway at a high velocity, it may not be feasible to perform the mitigation strategy. Furthermore, transitioning between different mitigation strategies based on an identified risk may be challenging due to the interplay between varies components of the vehicle entailed in the transition.

The present disclosure addresses the above-noted and other deficiencies by using a processing device of a vehicle to execute automotive composable security defense levels. In an example, the vehicle may be operating at a first safety level from amongst a plurality of safety levels. The processing device may determine that the vehicle is to transition to a second safety level in the plurality of safety levels based on a variety of factors. A service executed by the processing device may monitor and coordinate the transition from the first safety level to the second safety level. For instance, the service may emit notifications to ECUs of the vehicle indicating the transition. The service may also ensure that transitioning between the first safety level and the second safety level is safe. In some aspects, the service may be guided by a state machine to ensure well-defined states and transitions. In some aspects, transitioning between the first safety level and the second safety level may include disabling a first automotive security profile associated with the first safety level and enabling a second automotive security profile associated with the second safety level. The first automotive security profile and/or the second automotive security profile may provide a declarative mechanism to define characteristics and operating behaviors of the different safety levels. In an example, the second automotive security profile may include information that, when implemented by the vehicle, adjusts an operational parameter of an ECU of the vehicle in order to mitigate a security threat to the vehicle based on the second safety level.

In an example, a processing device obtains, via a service, a request to transition a vehicle from a first safety level to a second safety level, where the first safety level and the second safety level are associated with an embedded system of the vehicle. The processing device validates, via the service, the request based on a set of security conditions. The processing device transitions, via the service, the vehicle from the first safety level to the second safety level based on the validated request. The processing device adjusts an operational parameter of the embedded system based on the transition from the first safety level to the second safety level.

As discussed herein, the present disclosure provides an approach that improves the operation of a computer system by reducing an amount of computing resources used to mitigate a security threat. For instance, vis-à-vis validating, via the service, the request based on a set of security conditions and transitioning the vehicle from the first safety level to the second safety level based on the validated request, computing resources may be conserved. Furthermore, as discussed herein, the present disclosure provides an approach that improves the technological field of automotive security by preventing embedded systems (e.g., ECUs) of a vehicle from being compromised or making the embedded systems less likely to be compromised. For instance, vis-à-vis validating, via the service, the request based on a set of security conditions and transitioning the vehicle from the first safety level to the second safety level based on the validated request, the embedded system of the vehicle may be prevented from being compromised or the embedded system of the vehicle may be less likely to be compromised.

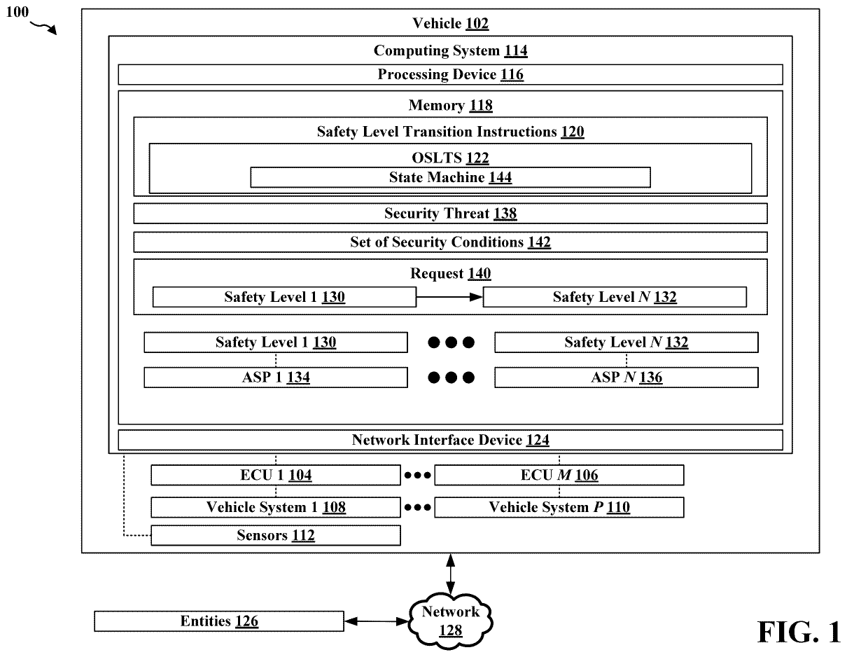

FIG. 1 is a block diagram 100 that illustrates an example of a vehicle 102 in accordance with some aspects of the present disclosure. In an example, the vehicle 102 may be or include a land-based vehicle, a sea-based vehicle, an air-based vehicle, and/or a space-based vehicle. In an example, a land-based vehicle may be or include a car, a truck, a train, a bus, and/or a motorcycle. In an example, a sea-based vehicle may or include be a boat and/or a submarine. In an example, an air-based vehicle may be or include a plane, a helicopter, and/or a drone. The vehicle 102 may be a non-autonomous vehicle (i.e., a vehicle that requires human input to operate), a semi-autonomous vehicle (i.e., a vehicle that is capable of performing certain functionality without human input), or an autonomous vehicle (i.e., a vehicle that is able to operate without human input). In some aspects, a non-autonomous vehicle may refer level zero of the Society of Engineers (SAE) levels of autonomous driving. Level zero of the SAE levels of autonomous driving refers to a vehicle in which a driver is responsible for all aspects of driving, even when enhanced by warning and/or intervention levels. In some aspects, a semi-autonomous vehicle may refer to level one, level two, level three, or level four of the SAE levels of autonomous driving. Level one of the SAE levels of autonomous driving refers to a vehicle that can assist with either steering (e.g., lane-keeping assist) or acceleration/deceleration (e.g., adaptive cruise control), but not both simultaneously. Level two of the SAE levels of autonomous driving refers to a vehicle that can assist with both steering and acceleration/deceleration, but the driver remains in control and is ready to take over operation of the vehicle at any moment. Level three of the SAE levels of autonomous driving refers to a vehicle that can handle most driving tasks under specific conditions, but the driver is ready to take over when requested by the vehicle. Level four of the SAE levels of autonomous driving refers to a vehicle that can handle all driving tasks under specific conditions, and the driver is not actively involved in driving tasks. In some aspects, an autonomous vehicle may refer to level five of the SAE levels of autonomous driving. Level five of the SAE levels of autonomous driving refers to a vehicle that can handle all driving tasks in all conditions without any human intervention.

The vehicle 102 may include a first ECU 104 and an Mth ECU 106, where M is a positive integer greater than one. An ECU (which may also be referred to as an electronic control module) may refer to an embedded system (i.e., a specialized computer system that has a dedicated function within a larger system) in automotive electronics that controls one or more vehicle systems or vehicle subsystems in a car or other motor vehicle. The first ECU 104 and the Mth ECU 106 may be collectively referred to as a “plurality of ECUs 104-106.” In an example, the plurality of ECUs 104-106 may be or include a generic powertrain, a door control unit (DCU), an engine control unit, an electric power steering control unit (PSCU), a human-machine interface (HMI), a powertrain control module (PCM), a seat control unit, a speed control unit (SCU), a telematic control unit (TCU), a transmission control module (TCM), a brake control module, a battery management system (BMS), a central timing module (CTM), a general electronic module, a body control module, a suspension control module, a central control module, and/or a module associated with information and/or entertainment within the vehicle 102. Some or all of the plurality of ECUs 104-106 may communicate with one another or other computing devices via various interfaces. In an example, an ECU in the plurality of ECUs 104-106 may include a core (e.g., a microcontroller), memory (e.g., static random-access memory (SRAM), electrically erasable programmable read-only memory (EEPROM), flash memory, etc.), inputs (e.g., supply voltage and ground, digital inputs, analog inputs), outputs (e.g., actuator drivers, H bridge drivers for servomotors, logic outputs), communication links (e.g., housing, bus transceivers), and embedded software (e.g., a boot loader, metadata for ECU and software identification, version management, checksums, functional software routines, and configuration data).

The vehicle 102 may include a first vehicle system 108 and a Pth vehicle system 110, where P is a positive integer greater than one. In some aspects, M may be equal to P. In some aspects, M may not be equal to P. The first vehicle system 108 and the Pth vehicle system 110 may be collectively referred to as a “plurality of vehicle systems 108-110.” Each vehicle system in the plurality of vehicle systems 108-110 may be responsible for providing certain functionality to/for the vehicle 102. In an example, the plurality of vehicle systems 108-110 may be or include an engine system, a transmission system, an exhaust system, a fuel system, a braking system, a suspension system, a steering system, a drive train, an electrical system, a light system, a radio system, an air conditioning system, a heating system, an airbag system, a seatbelt system, an anti-lock braking system, a vehicular communication system, a navigation system, an information system, and/or an entertainment system.

Each vehicle system in the plurality of vehicle systems 108-110 may be associated with (e.g., integrated with, coupled to, in communication with, controlled by, etc.) one or more ECUs in the plurality of ECUs 104-106. In an example, the first vehicle system 108 may be associated with (e.g., integrated with, coupled to, in communication with, controlled by, etc.) the first ECU 104 and the Pth vehicle system 110 may be associated with (e.g., integrated with, coupled to, in communication with, controlled by, etc.) the Mth ECU 106. In some aspects, an ECU in the plurality of ECUs 104-106 may be associated with (e.g., integrated with, coupled to, in communication with, controlled by, etc.) more than one vehicle system in the plurality of vehicle systems 108-110.

The vehicle 102 may include sensors 112 that enable the vehicle to determine characteristics of an environment in which the vehicle 102 is located. In an example, the sensors 112 may be or include camera(s), video camera(s), radar sensor(s), light detection and ranging (LIDAR) sensor(s), and/or sound navigation and ranging (SONAR) sensor(s). In some aspects, the sensors 112 may include a global navigation satellite system (GNSS) module that enables the vehicle 102 to determine a location (e.g., a latitude and a longitude) of the vehicle 102.

The vehicle 102 may include a computing system 114. In an example, the computing system 114 may be or include the computer system 500 (or a portion thereof). The computing system 114 may be communicatively coupled to the plurality of ECUs 104-106, the vehicle systems 108-110, and/or the sensors 112. In some aspects, the computing system 114 may be or include an ECU, such as a central control module.

The computing system 114 may include a processing device 116 (e.g., a processor, such as one or more central processing units (CPUs), one or more graphics processing units (GPUs), etc.) and memory 118 (e.g., random access memory (RAM)). The memory 118 may store safety level transition instructions 120 that, when executed by the processing device 116, cause the processing device 116 to implement functionality pertaining to automotive composable security defense levels as described herein. In some aspects, the safety level transition instructions 120, when executed by the processing device 116, cause the processing device to provide an operation security level transitioning service (OSLTS) 122 (described in greater detail below).

The computing system 114 may include a network interface device 124 (e.g., a wireless local area network (WLAN) radio, a cellular radio, a Bluetooth® radio, a satellite radio, a Universal Serial Bus (USB) controller, etc.) that enables the computing system 114 (and hence, the vehicle 102) to communicate with entities 126 inside and/or outside of the vehicle 102 over a network 128. The entities 126 may be or include smartphone(s), desktop computing device(s), laptop computing device(s), tablet computing device(s), wearable computing device(s), extended reality (XR) computing device(s), gaming console(s), server computing device(s), cloud computing device(s), edge device(s), Internet-of-Things (IoT) device(s), RSU(s), and/or other vehicle(s).

The network 128 may be a public network (e.g., the Internet), a private network (e.g., a local area network (LAN) or a wide area network (WAN)), or a combination thereof. In one example, the network 128 may include a wired and/or a wireless infrastructure, which may be provided by one or more wireless communications systems, such as a WiFi™ hotspot connected with the network 128 and/or a wireless carrier system that can be implemented using various data processing equipment, communication towers (e.g., cell towers), etc. The network 128 may carry communications (e.g., data, messages, packets, frames, etc.) between computing devices.

It is to be understood that the computing system 114 and/or the vehicle 102 may include elements not depicted in FIG. 1, such as storage devices (e.g., a hard-disk drive (HDD), a solid-state drive (SSD), etc.) and/or other hardware devices (e.g., a sound card, etc.). A storage device may include a persistent storage that is capable of storing data. A persistent storage may be a local storage unit or a remote storage unit. Persistent storage may be a magnetic storage unit, an optical storage unit, a solid state storage unit, electronic storage units (main memory), or similar storage unit. Persistent storage may also be a monolithic/single device and/or a distributed set of devices.

The memory 118 may include a first safety level 130 and an Nth safety level 132, where N is a positive integer greater than one. The first safety level 130 and the Nth safety level 132 may be collectively referred to as a “plurality of safety levels 130-132.” A safety level may alternatively be referred to as “a security level” or “a security/safety level.” In an example, the vehicle 102 may be configured with the plurality of safety levels 130-132 when the vehicle 102 is manufactured and/or when the vehicle 102 undergoes service. In some aspects, a cloud computing device in the entities 126 may configure the vehicle 102 with the plurality of safety levels 130-132 (or update the plurality of safety levels 130-132) on a periodic basis (e.g., at night when the vehicle 102 is not in use).

A safety level in the plurality of safety levels 130-132 may be indicative of a level of a security threat to the vehicle 102. In an example, N is five, and as such, the plurality of safety levels 130-132 may include level zero (no danger), level one (low danger), level two (medium danger), level three (high danger), and level four (critical danger). In an example, a relatively low safety level in the plurality of safety levels 130-132 may be indicative of no threat or a lesser threat to the vehicle 102 (e.g., exposure of details of account information of an entertainment system of the vehicle) and a relatively high safety level may be indicative of a more serious threat to the vehicle 102 (e.g., a loss of control of a steering system of the vehicle 102).

It is contemplated that the vehicle 102 may operate in one of the plurality of safety levels 130-132 at a given time. The vehicle 102 (via the computing system 114) may determine which safety level in the plurality of safety levels 130-132 that the vehicle 102 is to operate in based on a variety of factors. The variety of factors may include sensor data from the sensors 112, an environmental condition (e.g., the vehicle 102 entering a known danger area), communications received by/transmitted from the vehicle 102 (e.g., communications from a cloud computing device in the entities 126), an analysis of communications received by/transmitted from the vehicle 102 (e.g., an analysis of packets received by the vehicle 102 from an entity in the entities 126, such as an analysis performed using an Extended Berkeley Packet Filter (eBPF) tool), a functional safety (FuSa) rule, a current state of the vehicle 102 (e.g., whether the vehicle 102 is exhibiting abnormal behavior), and/or a user request from a driver of the vehicle 102.

The memory 118 may include a first automotive security profile (ASP) 134 and an Nth ASP 136. The first ASP 134 and the Nth ASP 136 may be collectively referred to as a “plurality of ASPs 134-136.” Each ASP in the plurality of ASPs 134-136 may be associated with (e.g., linked to) a safety level in the plurality of safety levels 130-132. For example, the first ASP 134 may be associated with the first safety level 130 and the Nth ASP 136 may be associated with the Nth safety level 132.

In general, an ASP in the plurality of ASPs 134-136 may include information about characteristics and/or operational behaviors belonging to a safety level in the plurality of safety levels 130-132. Each ASP in the plurality of ASPs 134-136 may be associated with one or more ECUs in the plurality of ECUs 104-106. In an example, the first ASP 134 may be associated with first operational parameters of the first ECU 104 and the Nth ASP 136 may be associated with second operational parameters of the first ECU 104, where the first operational parameters may be different from the second operational parameters. For instance, the first operational parameters may be associated with the first ECU 104 operating normally, whereas the second operational parameters may be associated with adjusting operation of the first ECU 104 (e.g., disabling the first ECU 104, disabling a feature of the first ECU 104, preventing the first ECU 104 from communicating with other ECUs in the plurality of ECUs 104-106, preventing the first ECU 104 from accepting an update, etc.). In another example, the first ASP 134 may indicate that the first ECU 104 (e.g., car entertainment functionality) and the Mth ECU 106 (e.g., self-driving functionality) are to be allowed to operate, whereas the Nth ASP 136 may indicate that the first ECU 104 (e.g., car entertainment functionality) is to be allowed to operate, but the Mth ECU 106 (e.g., self-driving functionality) is to be disabled.

In some aspects, an ASP in the plurality of ASPs 134-136, such as the first ASP 134 and/or the Nth ASP 136, may include information pertaining to a standard, such as a standard associated with Functional Safety (FuSa) and/or a standard associated with an automotive safety integrity level (ASIL) in order to facilitate compliance of the vehicle 102 with regulations in different jurisdictions (e.g., different countries). FuSa may be defined as the absence of unacceptable risk due to hazards caused by malfunctioning behavior of electrical and/or electronic systems of a vehicle. A goal of FuSa may be to prevent systematic design failures and to detect and control random hardware faults. FuSa may be related to an automotive safety integrity level (ASIL). ASIL may refer to a risk classification scheme that helps to define safety requirements. A malfunctioning resource of a vehicle may be identified by one of four ASIL levels: ASIL A (lowest hazard), ASIL B, ASIL C, or ASIL D (highest hazard). An ASIL level of a resource (e.g., a vehicle system or an ECU) may be based on a severity of the failure of the resource, a likelihood of the failure occurring, and how much time the vehicle 102 is exposed to the failure of the resource.

In an example, the vehicle 102 may be configured with the plurality of ASPs 134-136 when the vehicle 102 is manufactured and/or when the vehicle 102 undergoes service. In some aspects, a cloud computing device in the entities 126 may configure the vehicle 102 with the plurality of ASPs 134-136 (or update the plurality of ASPs 134-136) on a periodic basis (e.g., at night when the vehicle 102 is not in use).

As discussed above, it is contemplated that the vehicle 102 may operate in one of the plurality of safety levels 130-132 at a given time, and as such, it is also contemplated that one ASP in the plurality of ASPs 134-136 may be active at a given time. As will be described in greater detail below, the OSLTS 122 may manage transitions between the plurality of safety levels 130-132 (and hence transitions between different ASPs in the plurality of ASPs 134-136).

In an example, the vehicle 102 may be operating according to the first safety level 130 and as such, the first ASP 134 may be active. The vehicle 102 may detect a security threat 138 to the vehicle 102. For example, the vehicle 102 may detect the security threat 138 to the vehicle 102 based on sensor data from the sensors 112, an environmental condition (e.g., the vehicle 102 entering a known danger area), communications received by/transmitted from the vehicle 102 (e.g., communications from a cloud computing device in the entities 126), an analysis of communications received by/transmitted from the vehicle 102 (e.g., an analysis of packets received by the vehicle 102 from an entity in the entities 126, such as an analysis performed using an eBPF tool), a FuSa rule, a current state of the vehicle 102 (e.g., whether the vehicle 102 is exhibiting abnormal behavior), and/or a user request from a driver of the vehicle 102.

Based on detection of the security threat 138, the OSLTS 122 may obtain a request 140 to transition the vehicle 102 from the first safety level 130 to the Nth safety level 132 (or another safety level in the plurality of safety levels 130-132, such as a second safety level (not depicted in FIG. 1)). In some aspects, obtaining the request 140 may include the OSLTS 122 generating the request based on the detection of the security threat 138. In some aspects, obtaining the request 140 may include receiving the request 140 from one or more ECUs in the plurality of ECUs 104-106. In some aspects, obtaining the request 140 may include receiving the request 140 from one or more of the plurality of vehicle systems 108-110. In some aspects, obtaining the request 140 may include receiving the request 140 based on user input from a driver of the vehicle 102. In some aspects, obtaining the request 140 may include receiving the request 140 from an entity (e.g., a cloud computing device that manages the vehicle 102 and other vehicles) in the entities 126.

The OSLTS 122 may validate the request 140 based on a set of security conditions 142. In an example, the set of security conditions may be or include an environmental condition, a user request, a current state of the vehicle 102, and/or a FuSa rule. In some aspects, validating the request may include OSLTS 122 determining a state of the vehicle 102. The OSLTS 122 may determine an amount of time that is to elapse before the request 140 can be granted based on the state of the vehicle 102. For instance, the amount of time may correspond to an amount of time for the vehicle 102 to come to a complete stop. The OSLTS 122 may grant the request after the amount of time has elapsed. Granting the request may include and/or be associated with transitioning the vehicle 102 from the first safety level 130 to the Nth safety level 132.

The OSLTS 122 may transition the vehicle 102 from the first safety level 130 to the Nth safety level 132 based on the (validated) request 140. In an example, transitioning the vehicle 102 from the first safety level 130 to the Nth safety level 132 may include disabling the first ASP 134 and enabling the Nth ASP 136. In another example, the first ASP 134 may define a first behavior for the first ECU 104 (e.g., allowing Bluetooth® devices to communicate with the first ECU 104) and the Nth ASP 136 may define a second behavior for the first ECU 104 (e.g., not allowing Bluetooth® devices to communicate with the first ECU 104), and disabling the first ASP 134 may cause the first ECU 104 to stop exhibiting the first behavior and enabling the Nth ASP 136 may cause the first ECU 104 to start exhibiting the second behavior.

In some aspects, validating the request 140 and/or transitioning the vehicle 102 from the first safety level 130 to the Nth safety level 132 may be based on a state machine 144 maintained by the OSLTS 122. A state machine may refer to a mathematical model of computation that describes a behavior of a system by defining a set of states and transitions between the states that are triggered by specific events or inputs. In an example, the OSLTS 122 may provide the request 140 as an input to the state machine 144 that reflects a set of states of the vehicle 102 including a current state of the vehicle 102. The OSLTS 122 may obtain, as an output of the state machine 144, an indication of a transition from the first safety level 130 to the Nth safety level 132, and the OSLTS 122 may transition the vehicle 102 from the first safety level 130 to the Nth safety level 132 based on the indication of the transitioned obtained as the output of the state machine 144.

The vehicle 102 may adjust an operational parameter of the first ECU 104 based on the transition from the first safety level 130 to the Nth safety level 132. For example, the vehicle 102 may disable the first ECU 104, disable a feature of the first ECU 104, prevent the first ECU 104 from communicating with another ECU, such as the Mth ECU 106, and/or prevent the first ECU 104 from accepting an update. In some aspects, adjusting the operational parameter of the first ECU 104 may cause operation of the first vehicle system 108 to be adjusted.

In some aspects, the OSLTS 122 may emit a notification to one or more of the plurality of ECUs 104-106 that indicates the transition from the first safety level 130 to the Nth safety level 132 and/or that indicates that an operational parameter of an ECU in the plurality of ECUs 104-106 is to be adjusted. In an example, the OSLTS 122 may emit the notification to the first ECU 104. The first ECU 104 may adjust the operational parameter based on the received notification.

In some aspects, the OSLTS 122 may obtain the request 140 at a first time instance and the OSLTS 122 may obtain a second request (not depicted in FIG. 1) at a second time instance that is different from the first time instance. The second request may be to transition the vehicle 102 from the first safety level 130 to a second safety level in the plurality of safety levels 130-132. The OSLTS 122 may validate the request 140 based on the second request. For instance, the OSLTS 122 may resolve conflicts between the request 140 and the second request in order to transition the vehicle 102 to a new safety level.

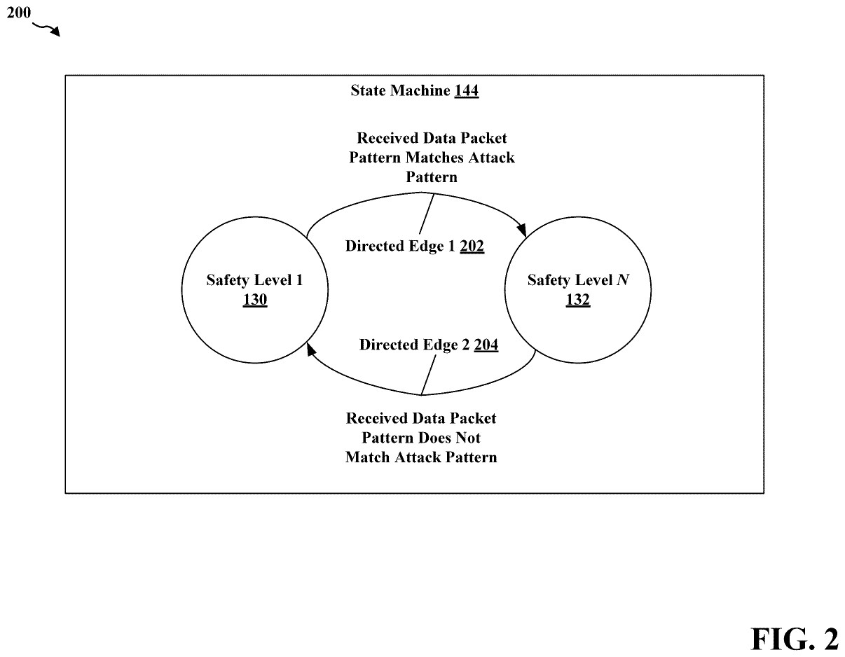

FIG. 2 is a block diagram 200 that illustrates an example of the state machine 144 in accordance with some aspects of the present disclosure. In an example, the state machine 144 may include an indication of the first safety level 130 and an indication of the Nth safety level 132. The state machine 144 may include a first directed edge 202 associated with a connection from the first safety level 130 to the Nth safety level 132 and a second directed edge 204 associated with a connection from the Nth safety level 132 to the first safety level 130. The first directed edge 202 may be associated with a first condition (e.g., a received data packet pattern matches an attack pattern) that, when met, may trigger the OSLTS 122 to transition the vehicle 102 from the first safety level 130 to the Nth safety level 132. The second directed edge 204 may be associated with a second condition (e.g., a received data packet pattern does not match an attack pattern) that, when met, may trigger the OSLTS 122 to transition the vehicle 102 from the Nth safety level 132 to the first safety level 130.

Cars and other vehicles may adopt technology that makes the cars and other vehicles equivalent to a computer from a certain point of view. Cars and other vehicles may be constantly exposed to potential attacks. Aspects presented herein pertain to introducing multiple security defense levels in an automotive context. In particular, some aspects presented herein pertain to protecting car functionality by excluding some ECUs related to particular features.

As discussed above, automotive vehicles may be seen as computers exposed to the whole physical world, including the Internet. As such, automotive vehicles may be at risk of being attacked or abused. Aspects presented herein pertain to intrinsic security mechanisms at an automotive software (i.e., computer-executable instructions) level to limit damages when a vehicle is exposed to a security risk.

Some aspects presented herein pertain to multiple security level features in an automotive context. A vehicle may operate according to predetermined security/safety levels. This may imply that specific functionality or behaviors of a vehicle may be reduced or even prohibited at specific security/safety levels, which may result in greater security for a vehicle while at the same time adhering to FuSa specifications.

In an example, a scale for security/safety levels may include critical danger (level four), high danger, (level three), medium danger (level two), low danger (level one), and no danger (level zero). In an example, a manufacturer of a vehicle may set a list of ECU exclusions via explicit rules. For example, at a low danger level, ECUs related to information and/or entertainment (i.e., “infotainment”) may be temporarily excluded. In another example, at a medium danger level, ECUs such as a seat control unit and/or a telematic control unit may be excluded. In yet another example, at a high danger level, certain important ECUs may stop accepting software updates. In a further example, at a critical danger level, a central control unit may be excluded, which may prevent other ECUs in the vehicle from communicating.

In some aspects presented herein, security defense levels and/or an ECU exclusion list may be different depending on whether a car is at rest (i.e., not moving) or is in transit (i.e., is moving). For instance, while a car is in transit, certain exclusions may not be possible due to FuSa reasons. In such a case, the car may suggest that the driver navigate to a safe location, stop the car at the safe location, and turn off the car so that security defense level and related actions may be safely performed by the car.

Some aspects presented herein pertain to an operation security level transitioning service (OSLTS) and automotive security profiles (ASPs). The OSLTS may be responsible for monitoring and coordinating security/safety level transitions. The OSLTS may emit a notification to various subsystems of a vehicle, where the notification indicates an updated security/safety level. The OSLTS may also be responsible for keeping track of requests that are asynchronous by nature, since altering a status of the vehicle may be unsafe from a FuSa point-of-view (e.g., a vehicle may be travelling at a relatively high speed on a motorway). The OSLTS may be guided by a state machine that facilitates well-defined states and transitions between different security/safety levels.

The ASPs may provide a declarative manner to define characteristics and operational behaviors belonging to different security/safety levels. The ASPs may be based on a Linux® architecture that provides for the concept of profiles and offers a daemon to enforce the ASPs. The ASPs may allow different levels of criticality to be defined. The ASPs may also correspond to present and/or future standards (e.g., FuSa standards, automotive safety integrity level (ASIL), etc.). ASPs that correspond to present and/or future standards may be useful in light of a global market economy where different safety rules may apply in different countries.

An example ASP may be or include the following:
#Automotive Security Profile
[ISO26262_L1_EU]
summary=Security profile L1
include=ISO26262_LO_EU
use=ECU1
use=ECU2
use=ECU3
infotainment.usb_input=deny
infotainment.BT_input=allow
. . .
self-driving. system_update=allow.

The aspects presented herein may be associated with various advantages. For instance, the aspects presented herein may protect ECUs of a car from being compromised. Furthermore, the aspects presented herein may be compatible with industry standards (e.g., FuSa) and may be flexible to global and evolving safety policies.

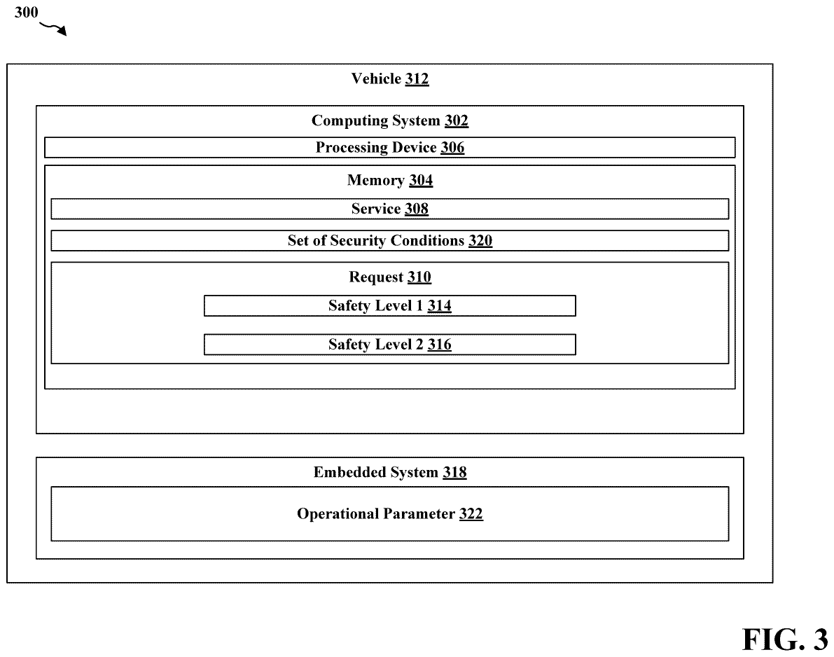

FIG. 3 is a block diagram 300 that illustrates an example system in accordance with some aspects of the present disclosure. The system includes a computing system 302. The computing system 302 includes a memory 304 and a processing device 306. The processing device 306 is operatively coupled to the memory 304 to: obtain, via a service 308, a request 310 to transition a vehicle 312 from a first safety level 314 to a second safety level 316, where the first safety level 314 and the second safety level 316 are associated with an embedded system 318 of the vehicle 312; validate, via the service 308, the request 310 based on a set of security conditions 320; transition, via the service 308, the vehicle 312 from the first safety level 314 to the second safety level 316 based on the (validated) request 310; and adjust an operational parameter 322 of the embedded system 318 based on the transition from the first safety level 314 to the second safety level 316.

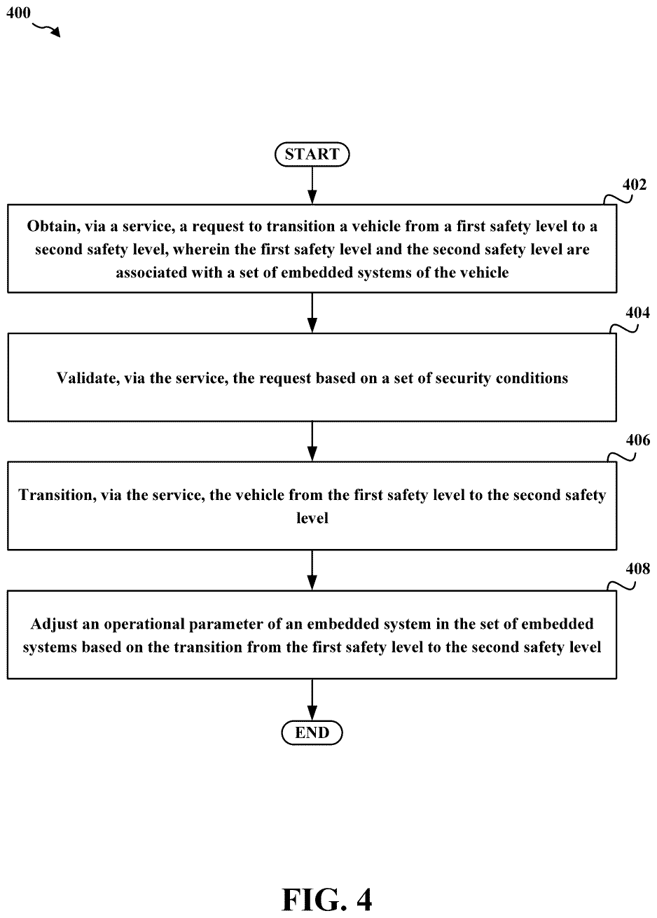

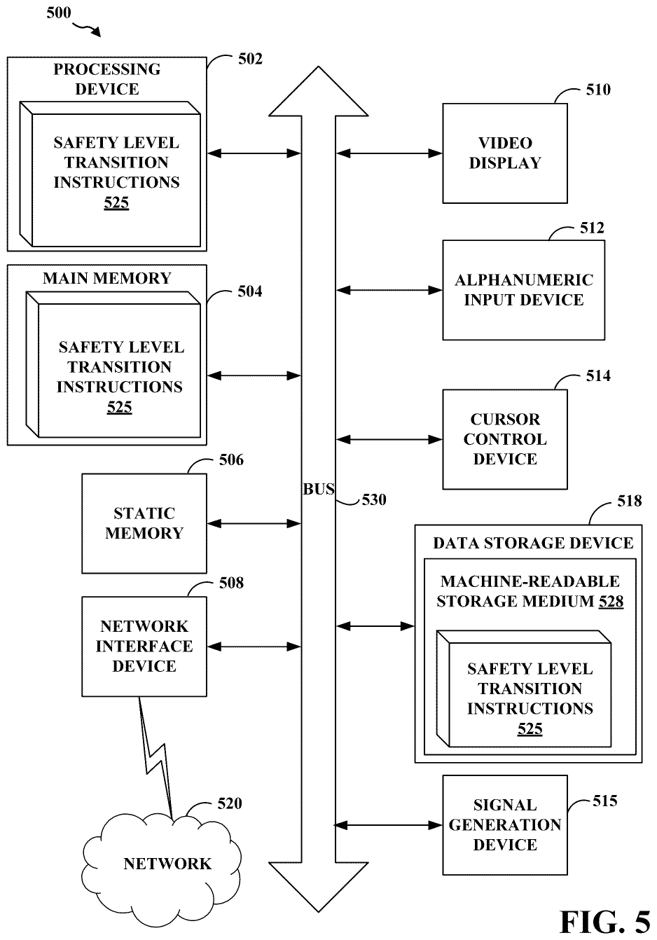

FIG. 4 is a flow diagram of a method 400 for automotive composable security defense levels in accordance with some aspects of the present disclosure. The method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some aspects, the method 400 may be performed at least in part by the vehicle 102 (illustrated in FIG. 1), the computing system 114 (illustrated in FIG. 1), the OSLTS 122 (illustrated in FIG. 1), the vehicle 312 (illustrated in FIG. 3), the computing system 302 (illustrated in FIG. 3), the processing device 306 (illustrated in FIG. 3), the service 308 (illustrated in FIG. 3), the computer system 500 (illustrated in FIG. 5), and/or the processing device 502 (illustrated in FIG. 5).

At block 402, processing logic obtains, via a service, a request to transition a vehicle from a first safety level to a second safety level, where the first safety level and the second safety level are associated with an embedded system of the vehicle. In an example, the service may be or include the OSLTS 122 and/or the service 308. In an example, the request may be or include the request 140 and/or the request 310. In an example, the vehicle may be or include the vehicle 102 and/or the vehicle 312. In an example, the first safety level may be the first safety level 130 and the second safety level may be the Nth safety level 132. In another example, the first safety level may be the first safety level 314 and the second safety level may be the second safety level 316. In an example, the embedded system may be or include the first ECU 104 and/or the embedded system 318.

At block 404, the processing logic validates, via the service, the request based on a set of security conditions. In an example, the set of security conditions may be or include the set of security conditions 142 and/or the set of security conditions 320.

At block 406, the processing logic transitions, via the service, the vehicle from the first safety level to the second safety level based on the validated request. In an example, the OSLTS 122 may transition the vehicle 102 from the first safety level 130 to the Nth safety level 132 based on the (validated) request 140. In another example, the service 308 may transition the vehicle 312 from the first safety level 314 to the second safety level 316 based on the (validated) request 310.

At block 408, the processing logic adjusts an operational parameter of the embedded system based on the transition from the first safety level to the second safety level. For example, the vehicle 102 may adjust an operational parameter of the first ECU 104 based on the transition from the first safety level 130 to the Nth safety level 132. In another example, the operational parameter may be or include the operational parameter 322.

In some aspects, transitioning the vehicle from the first safety level to the second safety level may include: disabling a first automotive security profile corresponding to the first safety level and enabling a second automotive security profile corresponding to the second safety level. For example, the first automotive security profile may be the first ASP 134 and the second automotive security profile may be the Nth ASP 136.

In some aspects, the first automotive security profile may define a first behavior for the embedded system, the second automotive security profile may define a second behavior for the embedded system, disabling the first automotive security profile may include causing the embedded system to stop exhibiting the first behavior, and enabling the second automotive security profile may include causing the embedded system to start exhibiting the second behavior. For example, the first ASP 134 may define a first behavior for the first ECU 104, the Nth ASP 136 may define a second behavior for the first ECU 104, disabling the first ASP 134 may include causing the first ECU 104 to stop exhibiting the first behavior, and enabling the Nth ASP 136 may include causing the first ECU 104 to start exhibiting the second behavior.

In some aspects, adjusting the operational parameter of the embedded system may include at least one of: disabling the embedded system, disabling a feature of the embedded system, preventing the embedded system from communicating with a second embedded system, or preventing the embedded system from accepting an update. For example, adjusting the operational parameter of the first ECU 104 may include disabling the first ECU 104, disabling a feature of the first ECU 104, preventing the first ECU 104 from communicating with another ECU (e.g., the Mth ECU 106), or preventing the first ECU 104 from accepting an update.

In some aspects, the embedded system may include an electronic control unit (ECU), and transitioning the vehicle from the first safety level to the second safety level may include emitting a notification to the ECU of the vehicle, where the notification may indicate that the operational parameter of the ECU is to be adjusted; and adjusting, by the ECU, the operational parameter of the ECU based on the notification. For example, transitioning the vehicle 102 from the first safety level 130 to the Nth safety level 132 may include emitting a notification to the first ECU 104 of the vehicle 102, where the notification may indicate that the operational parameter of the first ECU 104 is to be adjusted, and the first ECU 104 may adjust the operational parameter based on the notification.

In some aspects, validating the request may include providing the request as an input to a state machine that reflects a set of states of the vehicle including a current state of the vehicle; and obtaining, as an output of the state machine, an indication of a transition, where transitioning the vehicle from the first safety level to the second safety level may be based on the indication of the transition. For example, the state machine may be or include the state machine 144.

In some aspects, the request is obtained at a first time instance, and the processing logic may obtain, at a second time instance that is different from the first time instance and via the service, a second request to transition the vehicle from the first safety level to a third safety level, and validating the request may be additionally based on the second request. For example, the aforementioned aspects may correspond to the description of FIG. 1 above.

In some aspects, the vehicle may include at least one of: a land vehicle, a sea vehicle, or an air vehicle. For example, the vehicle 102 may be or include a land vehicle, a sea vehicle, and/or an air vehicle

In some aspects, the set of security conditions may be associated with at least one of: an environmental condition, a user request, a current state of the vehicle, or a functional safety (FuSa) rule. For example, the set of security conditions 142 may be associated with an environmental condition, a user request, a current state of the vehicle, and/or a FuSa rule.

In some aspects, the processing logic may detect a security threat to the vehicle, where obtaining the request may be based on the detected security threat. For example, the security threat may be or include the security threat 138.

In some aspects, validating the request may include determining a state of the vehicle; determining an amount of time that is to elapse before the request can be granted based on the state of the vehicle; and granting the request after the amount of time has elapsed, where transitioning the vehicle from the first safety level to the second safety level may be based on the request being granted. For example, the aforementioned aspects may correspond to the description of FIG. 1 above.

In some aspects, the embedded system may be coupled to a vehicle system of the vehicle, and adjusting the operational parameter of the embedded system may cause operation of the vehicle system to be adjusted. For example, the first ECU 104 may be coupled to the first vehicle system 108, and adjusting the operational parameter of the first ECU 104 may cause operation of the first vehicle system 108 to be adjusted.

FIG. 5 illustrates a diagrammatic representation of a machine in the example form of a computer system 500 within which a set of instructions, for causing the machine to perform any one or more of the methodologies discussed herein for automotive composable security defense levels. More specifically, the machine may obtain, via a service, a request to transition a vehicle from a first safety level to a second safety level, wherein the first safety level and the second safety level are associated with an embedded system of the vehicle; validate, via the service, the request based on a set of security conditions; transition, via the service, the vehicle from the first safety level to the second safety level based on the validated request; and adjust an operational parameter of the embedded system based on the transition from the first safety level to the second safety level.

In alternative aspects, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or a bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one aspect, the computer system 500 may be representative of a server.

The computer system 500 includes a processing device 502, a main memory 504 (e.g., read-only memory (ROM), flash memory, dynamic random access memory (DRAM), a static memory 506 (e.g., flash memory, static random access memory (SRAM), etc.), and a data storage device 518, which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

The computer system 500 may further include a network interface device 508 which may communicate with a network 520. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 515 (e.g., a speaker). In one example, the video display unit 510, the alphanumeric input device 512, and the cursor control device 514 may be combined into a single component or device (e.g., an LCD touch screen).

The processing device 502 represents one or more general-purpose processing devices such as a microprocessor, a central processing unit, or the like. More particularly, the processing device 502 may be a complex instruction set computing (CISC) microprocessor, a reduced instruction set computer (RISC) microprocessor, a very long instruction word (VLIW) microprocessor, or a processor implementing other instruction sets, or processors implementing a combination of instruction sets. The processing device 502 may also be one or more special-purpose processing devices such as an application specific integrated circuit (ASIC), a field programmable gate array (FPGA), a digital signal processor (DSP), a network processor, or the like. The processing device 502 is configured with safety level transition instructions 525, for performing the operations and steps discussed herein. For example, the safety level transition instructions 525 may include instructions for automotive composable security defense levels.

The data storage device 518 may include a machine-readable storage medium 528 (e.g., a non-transitory computer-readable medium) storing safety level transition instructions 525 (e.g., software) thereon embodying any one or more of the methodologies of functions described herein. The safety level transition instructions 525 may also reside, completely or partially, within the main memory 504 or within the processing device 502 during execution thereof by the computer system 500; the main memory 504 and the processing device 502 also constituting machine-readable storage media. The safety level transition instructions 525 may further be transmitted or received over the network 520 via the network interface device 508.

The machine-readable storage medium 528 may also be used to store the safety level transition instructions 525 to perform a method for automotive composable security defense levels, as described herein. While the machine-readable storage medium 528 is shown in an exemplary aspect to be a single medium, the term “machine-readable storage medium” should be taken to include a single medium or multiple media (e.g., a centralized or distributed database, or associated caches and servers) that store the one or more sets of instructions. A machine-readable storage medium includes any mechanism for storing information in a form (e.g., software, processing application) readable by a machine (e.g., a computer). The machine-readable storage medium may include, but is not limited to, a magnetic storage medium (e.g., floppy diskette), an optical storage medium (e.g., CD-ROM), a magneto-optical storage medium, a read-only memory (ROM), random-access memory (RAM), erasable programmable memory (e.g., EPROM and EEPROM), flash memory, or another type of medium suitable for storing electronic instructions.

The preceding description sets forth numerous specific details such as examples of specific systems, components, methods, and so forth, in order to provide a good understanding of several aspects of the present disclosure. It will be apparent to one skilled in the art, however, that at least some aspects of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular aspects may vary from these exemplary details and still be contemplated to be within the scope of the present disclosure.

Additionally, some aspects may be practiced in distributed computing environments where the machine-readable medium is stored on and or executed by more than one computer system. In addition, the information transferred between computer systems may either be pulled or pushed across the communication medium connecting the computer systems.

Aspects of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another aspect, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an aspect” or “one aspect” or “an implementation” or “one implementation” throughout is not intended to mean the same aspect or implementation unless described as such. Furthermore, the terms “first,” “second,” “third,” “fourth,” etc. as used herein are meant as labels to distinguish among different elements and may not necessarily have an ordinal meaning according to their numerical designation. Unless specifically stated otherwise, terms such as “obtaining,” “validating,” “transitioning,” “adjusting,” “disabling,” “enabling,” “causing,” “exhibiting,” “preventing,” “emitting,” “providing,” “transmitting,” “receiving,” “detecting,” “determining,” “identifying,” “granting,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass aspects in hardware, software, or a combination thereof.

What is claimed is:

1. A method, comprising:
obtaining, via a service, a request to transition a vehicle from a first safety level to a second safety level, wherein the first safety level and the second safety level are associated with an embedded system of the vehicle;
validating, via the service, the request based on a set of security conditions;
transitioning, by a processing device and via the service, the vehicle from the first safety level to the second safety level based on the validated request; and
adjusting an operational parameter of the embedded system based on the transition from the first safety level to the second safety level.

2. The method of claim 1, wherein transitioning the vehicle from the first safety level to the second safety level comprises:
disabling a first automotive security profile corresponding to the first safety level; and
enabling a second automotive security profile corresponding to the second safety level.

3. The method of claim 2, wherein the first automotive security profile defines a first behavior for the embedded system, wherein the second automotive security profile defines a second behavior for the embedded system, wherein disabling the first automotive security profile comprises causing the embedded system to stop exhibiting the first behavior, and wherein enabling the second automotive security profile comprises causing the embedded system to start exhibiting the second behavior.

4. The method of claim 1, wherein adjusting the operational parameter of the embedded system comprises at least one of:
disabling the embedded system;
disabling a feature of the embedded system;
preventing the embedded system from communicating with a second embedded system; or
preventing the embedded system from accepting an update.

5. The method of claim 1, wherein the embedded system comprises an electronic control unit (ECU), and wherein transitioning the vehicle from the first safety level to the second safety level comprises:
emitting a notification to the ECU of the vehicle, wherein the notification indicates that the operational parameter of the ECU is to be adjusted; and
adjusting, by the ECU, the operational parameter of the ECU based on the notification.

6. The method of claim 1, wherein validating the request comprises:
providing the request as an input to a state machine that reflects a set of states of the vehicle including a current state of the vehicle; and
obtaining, as an output of the state machine, an indication of a transition, wherein transitioning the vehicle from the first safety level to the second safety level is based on the indication of the transition.

7. The method of claim 1, wherein the request is obtained at a first time instance, the method further comprising:
obtaining, at a second time instance that is different from the first time instance and via the service, a second request to transition the vehicle from the first safety level to a third safety level, and wherein validating the request is additionally based on the second request.

8. The method of claim 1, wherein the vehicle comprises at least one of:
a land vehicle;
a sea vehicle; or an air vehicle.

9. The method of claim 1, wherein the set of security conditions is associated with at least one of:
an environmental condition;
a user request;
a current state of the vehicle; or
a functional safety (FuSa) rule.

10. The method of claim 1, further comprising:
detecting a security threat to the vehicle, wherein obtaining the request is based on the detected security threat.

11. The method of claim 1, wherein validating the request comprises:
determining a state of the vehicle;
determining an amount of time that is to elapse before the request can be granted based on the state of the vehicle; and
granting the request after the amount of time has elapsed, wherein transitioning the vehicle from the first safety level to the second safety level is based on the request being granted.

12. The method of claim 1, wherein the embedded system is coupled to a vehicle system of the vehicle, and wherein adjusting the operational parameter of the embedded system causes operation of the vehicle system to be adjusted.

13. A system, comprising:
a memory; and
a processing device, operatively coupled to the memory, to:
obtain, via a service, a request to transition a vehicle from a first safety level to a second safety level, wherein the first safety level and the second safety level are associated with an embedded system of the vehicle;
validate, via the service, the request based on a set of security conditions;
transition, via the service, the vehicle from the first safety level to the second safety level based on the validated request; and
adjust an operational parameter of the embedded system based on the transition from the first safety level to the second safety level.

14. The system of claim 13, further comprising:
a vehicle, wherein the memory and the processing device are included in the vehicle.

15. The system of claim 13, wherein to validate the request, the processing device is to:
provide the request as an input to a state machine that reflects a set of states of the vehicle including a current state of the vehicle; and
obtain, as an output of the state machine, an indication of a transition, wherein to transition the vehicle from the first safety level to the second safety level, the processing device is to transition the vehicle from the first safety level to the second safety level based on the indication of the transition.

16. The system of claim 13, wherein the embedded system comprises an electronic control unit (ECU), and wherein to transition the vehicle from the first safety level to the second safety level, the processing device is to:
emit a notification to the ECU of the vehicle, wherein the notification indicates that the operational parameter of the ECU is to be adjusted; and
adjust, by the ECU, the operational parameter of the ECU based on the notification.

17. A non-transitory computer-readable medium having instructions stored thereon which, when executed by a processing device, cause the processing device to:
obtain, via a service, a request to transition a vehicle from a first safety level to a second safety level, wherein the first safety level and the second safety level are associated with an embedded system of the vehicle;
validating, via the service, the request based on a set of security conditions;
transition, by the processing device and via the service, the vehicle from the first safety level to the second safety level based on the validated request; and
adjust an operational parameter of the embedded system based on the transition from the first safety level to the second safety level.

18. The non-transitory computer-readable medium of claim 17, wherein to validate the request, the instructions, when executed by the processing device, cause the processing device to:
provide the request as an input to a state machine that reflects a set of states of the vehicle including a current state of the vehicle; and
obtain, as an output of the state machine, an indication of a transition, wherein to transition the vehicle from the first safety level to the second safety level, the instructions, when executed by the processing device, cause the processing device to transition the vehicle from the first safety level to the second safety level based on the indication of the transition.

19. The non-transitory computer-readable medium of claim 17, wherein the embedded system comprises an electronic control unit (ECU), and wherein to transition the vehicle from the first safety level to the second safety level, the instructions, when executed by the processing device, cause the processing device to:
emit a notification to the ECU of the vehicle, wherein the notification indicates that the operational parameter of the ECU is to be adjusted; and
adjust, by the ECU, the operational parameter of the ECU based on the notification.

20. The non-transitory computer-readable medium of claim 17, wherein the set of security conditions is associated with at least one of:
an environmental condition;
a user request;
a current state of the vehicle; or
a functional safety (FuSa) rule.
